(19) United States
(12) Patent Application Publication
(10) Pub. No.: US 2023/0358340 A1
(43) Pub. Date: Nov. 9, 2023

(54) CONDUIT CLAMP SYSTEM AND METHOD OF USING THE SAME

(71) Applicant: Edward James Jaeger, Tacoma, WA (US)

(72) Inventor: Edward James Jaeger, Tacoma, WA (US)

(21) Appl. No.: 18/111,048

(22) Filed: Feb. 17, 2023

Related U.S. Application Data
(60) Provisional application No. 63/364,148, filed on May 4, 2022.

(51) Int. Cl. F16L 3/12

(52) U.S. Cl. CPC F16L 3/1222

(57) ABSTRACT

The present disclosure relates to a conduit clamp system and the method of using it. The conduit clamp system includes a U-shaped member configured to encircle around a portion of a first object. A loop clamp is configured to substantially encircle around a second object. A fastener is configured to rotationally couple the loop clamp with the U-shaped member such that the loop clamp can rotate in two directions relative to the U-shaped member along a longitudinal axis of the fastener. The fastener head is configured to be manipulated by the hands of a user in a tool-less manner.

### CROSS-REFERENCE TO RELATED APPLICATIONS

The present application hereby claims priority to and incorporates by reference the entirety of the disclosures of the provisional application No. 63/364,148 entitled “SHELF SUPPORT/CONDUIT CLAMP SYSTEM AND METHOD OF USING SAME” filed on May 4, 2022.

### BACKGROUND OF THE INVENTION

The present invention relates to conduit clamps and, more particularly, a conduit clamp system and a method of using the same to provide an adjustable, removable and multipurpose conduit clamp system for conduit-based construction, wherein the conduit clamp system includes an easily attachable loop clamp connectable to a U-shaped clamp by using a fastener that does not need tools.

### BACKGROUND

Most conduit clamps are large, cumbersome, unsightly and are required to be installed before modifications to a pipe/conduit-based shelving unit is constructed. Once a pipe or conduit unit is bolted, welded, and/or riveted into an assemblage, additions must be bolted, welded, and/or riveted to the unit, or the unit must be disassembled. As a result, changes often require the destruction of parts of or the entire assembly. Also, certain tools are required to affect these changes and additions to the unit, imposing another barrier to the modification of conduit-based units.

Virtually all other movable collars, clamps and adjusters encircle the entire pipe like a “donut”. Therefore, they must be constructed into an assembly and the number of the “donuts” must be precisely known during construction, else the above-mentioned changes must be effectuated. And so, once movable collars are installed, they must remain or be destroyed to be removed. Plus, none can be added even if more is desired without making the above-mentioned unsightly changes.

Many of the above changes also weaken the assembly. Once built, the conduit-based unit dimensions are permanent, and no easy adjustments or additions are currently possible. A useful means of making the above changes is by utilizing loop clamps. Loop clamps, however, are usually bolted or riveted on requiring drilling holes, weakening the structure. Also, many sites cannot fit a drill or the personnel to effectuate the changes.

Adjustable clamps like C-clamps or vice grips serve the similar purpose of clamping but are laughably conspicuous, unattractive, and expensive. Vendors and customers want accessories that do not look like accessories so as not to diminish the appeal of the original unit. Some pipe units use holes and pegs for adjustable shelves which weaken the entire structure.

Thus, the existing solutions related to conduit clamps are ineffective, and inefficient and require drilling holes in the frame, thus weakening the integrity of the frame. Further, existing solutions related to conduit clamps require special tools for clamping and unclamping of the conduit clamps. Thus, there is a need for a conduit clamp system and a method of using the same to enable adjustable, removable, multipurpose solutions for conduit-based construction, wherein the conduit clamp system includes an easily attachable or detachable loop clamp connectable to a U-shaped clamp using a toolless fastener. The system and method of the present invention facilitate adding wiring harnesses, linkages, additional conduits, and the like onto a pre-existing conduit or as a stand-alone addition without drilling any holes. The pre-existing conduit or a stand-alone addition may include a conduit along aircraft fuselages, ship bulkheads, vehicle frames such as semi-trailer frames, etc. The present invention can be added/removed easily without tools once a pipe/conduit unit has already been welded/constructed or installed (such as bolted to a wall). The present invention requires no tools for the ease of the end user. The present invention can be adjusted easily and allows for adding of more pipe/conduit or attachments post-construction.

### SUMMARY

While the way that the present disclosure addresses the disadvantages of the prior art will be discussed in greater detail below, in general, the present disclosure provides a conduit clamp system.

The present invention is related to a conduit clamp system that includes a sturdy U-shaped clamp that can be added to any pre-constructed pipe/conduit unit without tools OR fastened directly to a frame, bulkhead or fuselage, shelf or mantle etc. The clamp of the present invention is strong, attractive, removable, adjustable and appears to belong to the original construction. Its U-shaped form can be utilized on square, octagonal or round pipe/conduit. The conduit clamp system can effectively hold a plurality of loop clamps. Thus, the conduit clamp system effectively functions as a loop clamp holder that could be used for holding loop clamp(s) in various applications such as but not limited to: vehicle frames such as semi-trailer frames, aircraft fuselages, medical field, ship bulkheads, construction, automotive, aeronautic, or nautical, domestic use, furniture, factory use, pipes, tubes, ducts, bathroom fittings, woodworking, cabinet, shelving applications, after-market wiring harness, fuel lines, linkages and so on.

The present invention allows for design or functional changes after-the-fact-enabling aesthetically pleasing height, width, or depth changes. Also, the present invention allows for additions to the assembly after-the-fact that are as strong as the original unit and would appear to belong to the original unit. The present invention can be added/removed/adjusted easily in seconds and without damage to the base unit and without tools. The present invention can hold additional pipe/conduits matching the base unit, thus appearing factory-made.

The present invention is aesthetically pleasing and appears to be part of the original construction. Degrees of adjustment are innumerable, as is the scope of additions. The clamp can be rotated 360-degrees both vertically and horizontally allowing for infinitesimal applications, allowing for changes in the dimensions of the original unit, whether height, width or depth. The loop clamp embodied in the present invention can easily be installed without tools anywhere without drilling and is very secure temporarily or permanently.

The present disclosure overcomes the drawbacks of the existing devices by providing a conduit clamp system, comprising: a U-shaped member configured to encircle around at least a portion of a first object, wherein the U-shaped member comprises a screw hole, at least one loop clamp configured to substantially encircle around a second object, wherein the loop clamps comprises a first screw hole and a second screw hole, a fastener configured to extend through the first screw hole of the loop clamps, the second screw hole of the loop clamps as well as the screw hole of the U-shaped member, wherein the fastener comprises a fastener head, a screw portion comprising screw like threads, and a screw tip, Wherein the fastener is configured to rotationally couple the loop clamps with the U-shaped member such that the loop clamps can rotate in two directions relative to the U-shaped member along a longitudinal axis of the fastener; Wherein the fastener configured to be rotated in a first direction relative to the U-shaped member to enable the screw tip of the fastener to contact against the periphery of the first object, wherein the fastener head is configured to be manipulated by the hands of a user in a tool-less manner.

In an embodiment, the fastener is a thumbscrew.

In an embodiment, an elastic tube is configured to surround the screw portion of the fastener.

In an embodiment, the loop clamp is configured to rotate relative to the U-shaped member in 360 degrees of rotation.

In an embodiment, the first object and/or the second object is selected from a group comprising of: construction pipes, conduits, hoses, wiring harnesses, electrical conduits, bumper, mechanical linkages, frame rails, tubes, curtain rods, frame parts, rods, planks, plywood, auto frame, airplane/ship bulkhead, storage cabinet, and fireplace mantle.

In an embodiment, an inner portion of the U-shaped member and/or an inner portion of the loop clamp comprises a friction lining respectively.

In an embodiment, the conduit clamp system does not require any installation holes drilled in place.

Embodiments of the present invention disclose a method for constructing a shelf including a plurality of pipes and at least one wall element, the method comprising the steps of: Arranging at least one conduit clamp system ‘ on at least one of the pipe selected from the plurality of pipes arranged in a frame; wherein each of the conduit clamp systems’ comprises: a U-shaped member configured to encircle around at least a portion of a pipe, wherein the U-shaped member comprises a screw hole and a top surface, a fastener configured to extend through the screw hole of the U-shaped member, wherein the fastener comprises a fastener head, a screw portion comprising screw like threads, and a screw tip; rotating the fastener relative to the U-shaped member in a first direction to enable the screw tip of the fastener to contact against the periphery of the pipe, wherein the fastener head is configured to be manipulated by the hands of a user in a tool-less manner; arranging at least one wall element on top of the top surfaces of the U-shaped member wherein the top surfaces of the U-shaped member is configured to act as a resting surfaces for the wall elements.

In an embodiment, the method for constructing a shelf comprises additional step of forming a frame of the shelf by connecting a plurality of pipes. The plurality of pipes are connected by welding, snap-fitting, or threaded couplings.

In an embodiment, the wall elements is selected from group comprising of wooden plank, aluminum panels, trays, vacuum panels, and plastic panels.

In an embodiment, the wall elements are configured for storing and/or displaying articles that are placed on the wall elements.

### BRIEF DESCRIPTION OF THE DRAWINGS

A more complete understanding of the present disclosure may be derived by referring to the detailed description and claims when considered in connection with the figures, wherein like reference numerals refer to similar elements throughout the figures, and

FIG. 1 is a perspective view of a conduit clamp system in a first position, according to a first embodiment of the present invention.

FIG. 2 is a perspective view of a conduit clamp system in a second position, according to the first embodiment of the present invention.

FIG. 3 is an exemplary exploded view of the conduit clamp system of FIG. 2 in the second position, according to the first embodiment of the present invention.

FIG. 4 is a top view of the conduit clamp system of FIG. 2 in the second position, according to the first embodiment of the present invention.

FIG. 5 is a perspective view of a vehicle cable assembly installed using a plurality of conduit clamp systems of FIG. 2.

FIG. 6 is a sectional view of FIG. 5 showing the usage of a conduit clamp system of FIG. 2 for the vehicle cable assembly installation.

FIG. 7 is a perspective view of a curtain rod assembly installed using a pair of conduit clamp systems of FIG. 2.

FIG. 8 is a perspective view of a conduit clamp system, according to a second embodiment of the present invention.

FIG. 9 is an exemplary exploded view of the conduit clamp system of FIG. 8, according to a second embodiment of the present invention.

FIG. 10 is a top view of the conduit clamp system of FIG. 8, according to a second embodiment of the present invention.

FIG. 11 is a perspective view of a shelf constructed using a plurality of conduit clamp system of FIG. 8.

FIG. 12 is a sectional view of FIG. 11 showing the usage of a conduit clamp system of FIG. 8 for the shelf construction.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the present invention.

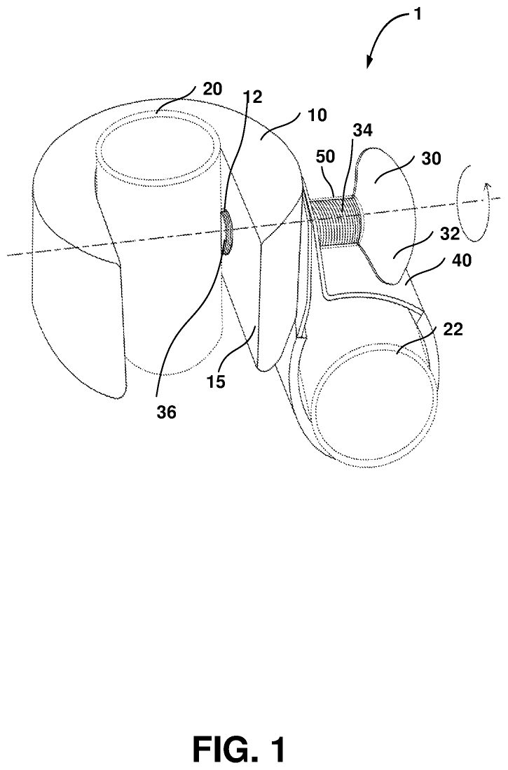

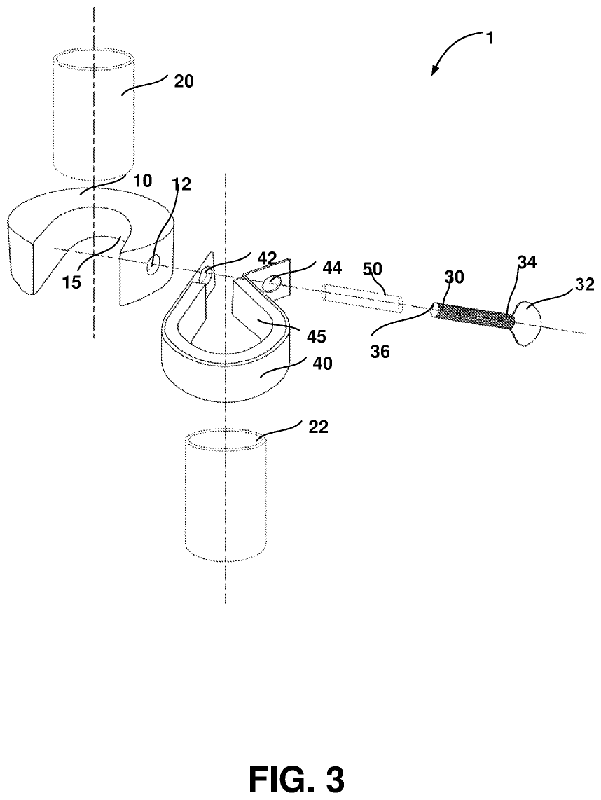

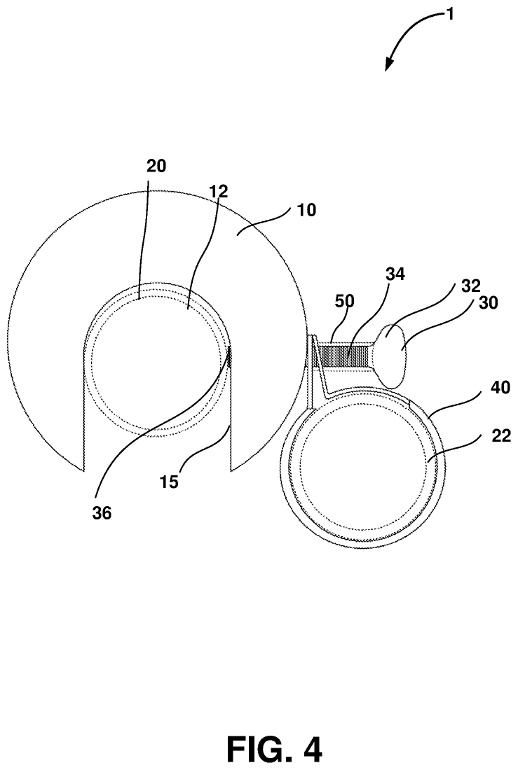

Referring now to FIGS. 1-7, the present invention is related to a conduit clamp system 1, according to a first embodiment of the present invention. The conduit clamp system 1 includes a U-shaped member 10. The present invention further includes a fastener 30, a loop clamp 40, and an optional elastic tube 50, the entirety of which will be later described in greater detail in the below description.

In an embodiment, the U-shaped member 10 may be a piece of thick-walled aluminum pipe measuring two-inches outside diameter and one-inch inside diameter with ½-inch walls notched to allow U-shaped member 10 to be slipped on to a one-inch or less outside diameter first object 20. In an embodiment, the fastener 30 is a 1½-inch long ¼-inch X 20 threads per inch thumbscrew. In an embodiment, the loop clamp 40 is a single or multiple ⅞-inch loop clamp with a ¼-inch mounting hole. In an embodiment, the elastic tube 50 is a one-inch section of a tube of ¼-inch inside diameter. It is understood that other dimensions and materials are contemplated herein.

The U-shaped member 10 is configured to encircle (nestle) around at least a portion of a first object 20. The U-shaped member 10 comprises a screw hole 12 that is configured to receive a fastener 30. The U-shaped member 10 comprises an inner portion 15 that is configured to engage against at least a portion of a first object 20 when the fastener 30 is tightened (rotated). The loop clamp 40 is configured to substantially encircle (nestle) around a second object 22. The loop clamp 40 comprises a first screw hole 42 and a second screw hole 44. Each of the first hole 42 and the second hole 44 are configured to receive a fastener 30. The loop clamp 40 comprises an inner portion 45 that is configured to engage against the second object 22 when the fastener 30 is tightened (rotated) in a first direction.

The fastener 30 comprises a fastener head 32, a screw portion 34 comprising screw like threads, and a screw tip 36. The fastener head 32 is configured to be manipulated by a user using their hands (thumb), without requiring any tools, in a tool-less manner. The fastener 30 is configured to rotationally couple the loop clamp 40 with the U-shaped member 10 such that the loop clamp 40 can rotate (tighten) relative to the U-shaped member 10 in two (both) directions along a rotation axis of the loop clamp 40 and vice-versa. The rotation axis of the loop clamp 40 and the longitudinal axis of the fastener 30 are substantially the same. Thus, the loop clamp 40 can rotate (tighten) relative to the U-shaped member 10 along a longitudinal axis of the fastener 30 and vice-versa. The fastener 30 extends (passes) through the first screw hole 42 of the loop clamp 40, the second screw hole 44 of the loop clamp 40 as well as the screw hole 12 of the U-shaped member 10. An elastic tube 50 (optional) surrounds the screw portion 34 of the fastener 30. Thus, the conduit clamp system 1 effectively functions as a loop clamp holder 1 that could be used for holding loop clamp(s) 40 in various applications such as but not limited to: vehicle frames such as semi-trailer frames, aircraft fuselages, medical field, ship bulkheads, construction, automotive, aeronautic, or nautical, domestic use, furniture, factory use, pipes, tubes, ducts, bathroom fittings, woodworking, cabinet, shelving applications, after-market wiring harness, fuel lines, linkages and so on.

As the U-shaped member 10 encircles around at least a portion of a first object 20, the fastener 30 is rotated (tightened) in a first direction relative to the U-shaped member 10 until screw tip 36 of the fastener 30 contacts the periphery of the first object 20. Similarly, when the fastener 30 is rotated (untightened) in a second opposite direction relative to the U-shaped member 10, the screw tip 36 of the fastener 30 now does not come in contact with the periphery of the first object 20. The loop clamp 40 substantially encircles around a second object 22. The loop clamp 40 can be rotated relative to the U-shaped member 10 in a complete 360-degree range of motion. Therefore, an infinite number of positions of the second object 22 relative to the first object 20 are possible to be achieved.

The optional elastic tube 50 serves the function of providing a tightening force for effective clamping of the second object 22 by using the loop clamp 40 such that the first screw hole 42 and the second screw hole 44 are effectively brought closer to each other, due to tightening force provided by the elastic tube 50.

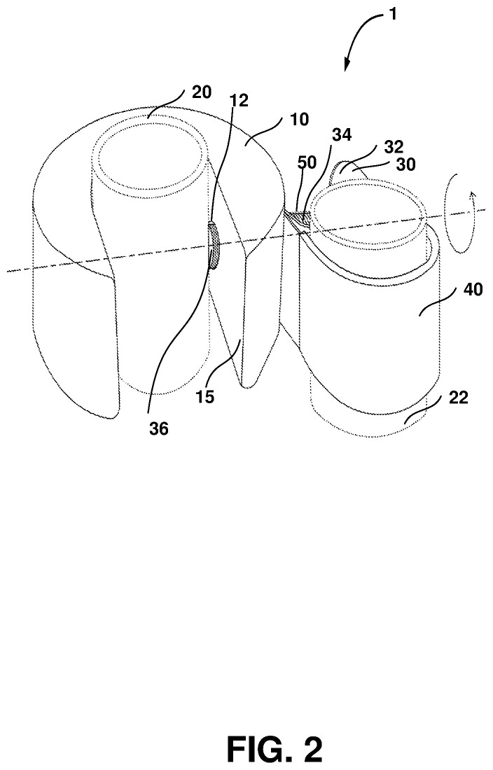

As shown in FIG. 1, the conduit clamp system 1 is positioned in a first position such that the second object 22 and the first object 20 are substantially perpendicular to each other. As shown in FIG. 2, the conduit clamp system 1 is now brought in a second position by rotating the loop clamp 40 relative to the U-shaped member 10 along a rotation axis of the loop clamp 40 by around 90 degrees such that the second object 22 and the first object 20 are substantially parallel to each other.

The first object 10 and/or the second object 22 could include any object having any shape and size capable of being clamped in the U-shaped member 10 and/or the loop clamp 30 respectively. The object of the first object 10 and/or the second object 22 can include but not limited to: construction pipes, conduits, hoses, wiring harnesses, bumpers, mechanical linkages, frame rails, tubes, frame parts, rods, planks, plywood, auto frame, airplane/ship bulkhead, storage cabinet or fireplace mantle and so on. The shape of the object can include but not limited to: circular, square, hexagon, rectangle, square, triangle, octagon and so on. Further, it should be understood that the first object 10 and/or the second object 22 could be any object depending on the application (field) use of the conduit clamp systems 1.

In an embodiment (not shown in figures), the U-shaped member 10 and/or the loop clamp 40 comprises a friction lining (not shown) in the inner portion 15 and the inner portion 45 respectively. The friction lining (not shown) is configured to resist rotation of the U-shaped member 10 relative to the first object 20 and/or the loop clamp 40 relative to the second object 22 when the fastener 30 is tightened.

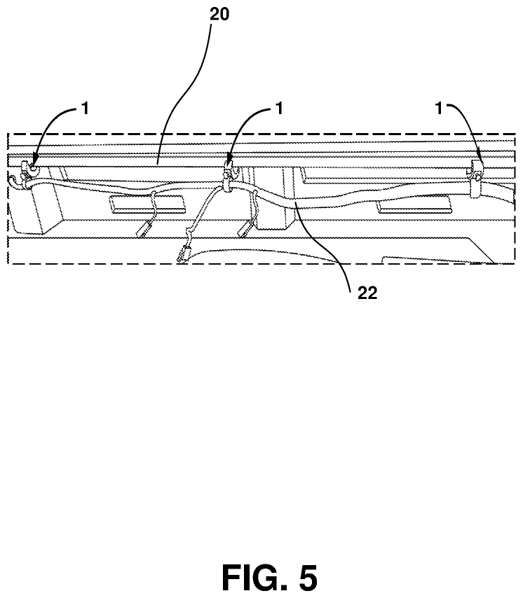

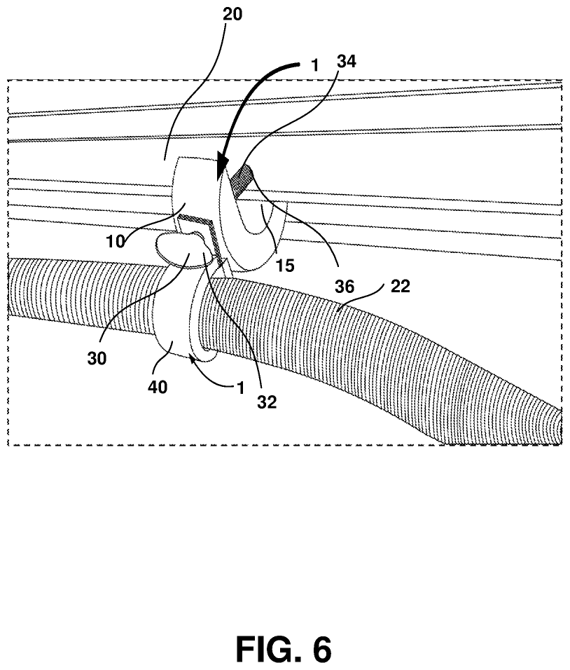

Referring to FIG. 5 and FIG. 6, a vehicle cable assembly is retro-fittingly (after-manufacture) installed using a plurality of conduit clamp systems 1. The U-shaped member(s) 10 of the plurality of conduit clamp systems 1 are configured to encircle (nestle) around at least a portion of a first object 20 wherein the first object 20 is a vehicle frame element. The loop clamp(s) 40 of the plurality of conduit clamp systems 1 are configured to substantially encircle (nestle) around a second object 22 wherein the second object 22 is an electric conduit pipe comprising a plurality of electrical cables arranged in the electric conduit pipe. Each fastener(s) 30 of the plurality of conduit clamp systems 1 is configured to rotationally couple a loop clamp 40 with a U-shaped member 10. Thus, a plurality of conduit clamp systems 1 are used in the installation of a vehicle cable assembly that includes an electric conduit pipe without drilling any holes in the vehicle frame element.

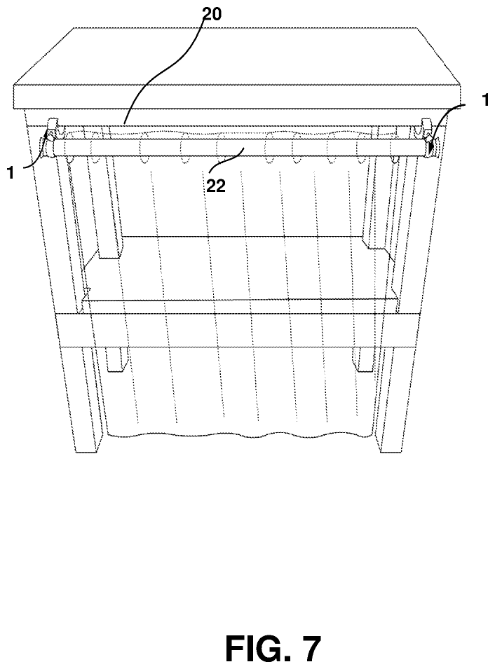

Referring to FIG. 7, a curtain rod assembly is installed using a pair of conduit clamp systems 1. The U-shaped member(s) 10 of the pair of conduit clamp systems 1 are configured to encircle (nestle) around at least a portion of a first object 20 wherein the first object 20 is a door frame element. The loop clamp(s) 40 of the pair of conduit clamp systems 1 are configured to substantially encircle (nestle) around a second object 22 wherein the second object 22 is a curtain rod holding a curtain. Each fastener(s) 30 of the pair of conduit clamp systems 1 is configured to rotationally couple a loop clamp 40 with a U-shaped member 10. Thus, a pair of conduit clamp systems 1 are used in the installation of a curtain rod assembly that includes a curtain rod without drilling any holes in the door frame element.

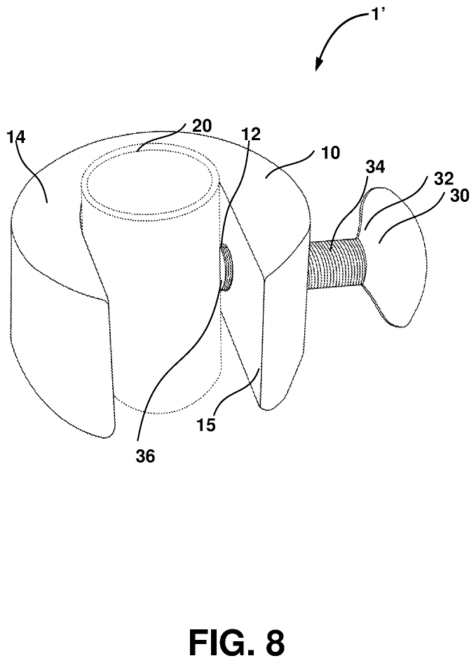

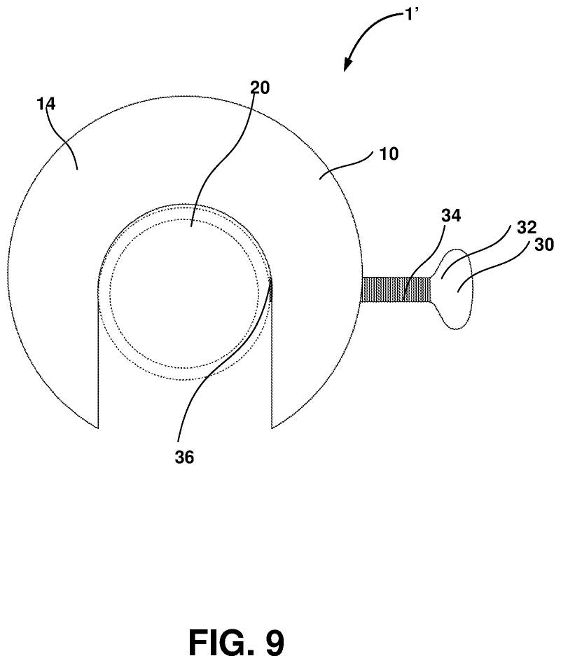

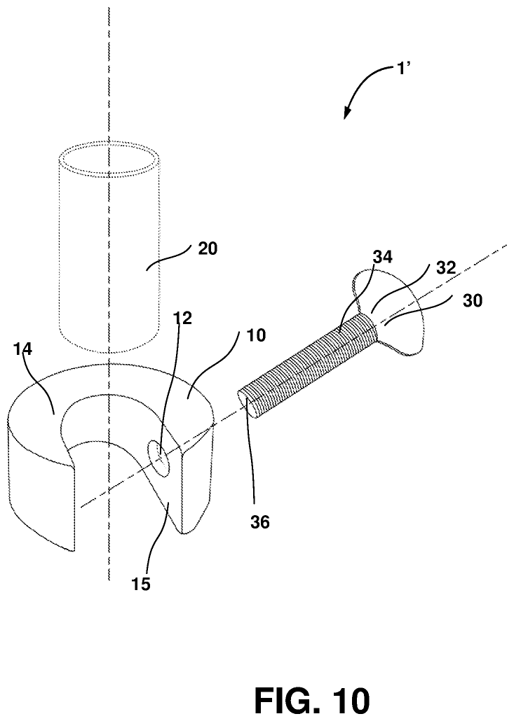

Referring now to FIGS. 8-12, the present invention is related to a conduit clamp system 1′, according to the second embodiment of the present invention. The conduit clamp system 1′ is similar to the conduit clamp system 1 of FIGS. 1-7 except that the conduit clamp system 1′ does not include a loop clamp 40 as well as an elastic tube 50. The conduit clamp system 1′ includes a U-shaped member 10 and a fastener 30, similar to the U-shaped member 10 and the fastener 30 of FIGS. 1-7.

In an embodiment, the U-shaped member 10 may be a piece of thick-walled aluminum pipe measuring two-inches outside diameter and one-inch inside diameter with ½-inch walls notched to allow U-shaped member 10 to be slipped on to a one-inch or less outside diameter pipe or conduit 20. In an embodiment, the fastener 30 is a 1′½-inch long ¼-inch X 20 threads per inch thumbscrew. It is understood that other dimensions and material are contemplated herein.

The U-shaped member 10 is configured to encircle (nestle) around at least a portion of a first object 20. The U-shaped member 10 comprises a screw hole 12 that is configured to receive a fastener 30. The U-shaped member 10 comprises a top surface 14 that acts as a resting surface which will be described in greater detail in below description. The fastener 30 comprises a fastener head 32, a screw portion 34 comprising screw like threads, and a screw tip 36. The fastener head 32 is configured to be manipulated by a user using their hands, without requiring any tools. The fastener 30 extends (passes) through the screw hole 12 of the U-shaped member 10.

As the U-shaped member 10 encircles around at least a portion of a first object 20, the fastener 30 is rotated in a first direction relative to the U-shaped member 10 until screw tip 36 of the fastener 30 contacts the periphery of the first object 20.

The U-shaped member 10 encircle (nestle) around at least a portion of a first object 20 and U-shaped member 10 has a sufficient thickness such that U-shaped member 10 can be drilled and tapped (threaded) to receive the fastener 30 and does not bend when the fastener 30 is rotated (tightened). The U-shaped member 10 can serve as a holder of shelves, additions, accessories. The U-shaped member 10 can support light to moderate weight or if needed can support quite heavy loads {such as a human's body weight} when doubled up with another U-shaped member 10 to work in tandem.

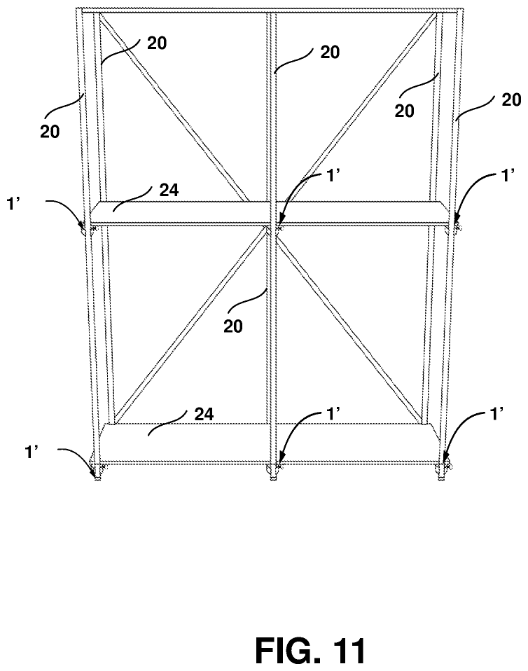

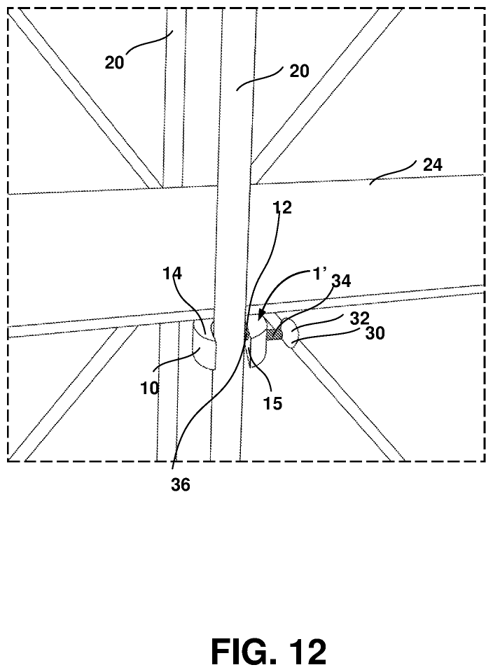

Referring to FIG. 11 and FIG. 12, a shelf is constructed using a plurality of conduit clamp systems 1′. The shelf is predominantly made of made of a plurality of pipes 20 (first object 20) that could be connected (welded, snap-fitted or threaded) together to form (define) a frame. The U-shaped member(s) 10 of the plurality of conduit clamp systems 1′ are configured to encircle (nestle) around at least a portion of a first object 20 wherein the first object 20 is a pipe. The U-shaped member 10 comprises a screw hole 12 that is configured to receive a fastener 30. The fastener 30 extends (passes) through the screw hole 12 of the U-shaped member 10. At least one wall element 24, such as but not limited to: a wooden plank is arranged (placed) on top of the top surface(s) 14 of the U-shaped member(s) 10 of the plurality of conduit clamp systems 1′. The top surface(s) 14 of the U-shaped member(s) 10 of the plurality of conduit clamp systems 1′ acts as a resting surface(s) (supporting surface) for the wall element 24. The wall element(s) 24 are configured for storing and/or displaying any article(s) that are placed on the wall element 24. The wall element(s) 24 have a predetermined spacing relative to each other. The plurality of conduit clamp systems 1′ are installed to each first object 20 (for instance, vertical pipe 20) after the shelf frame is formed. The plurality of conduit clamp systems 1′ are installed (slipped) onto a pipe of the frame and then, the fastener(s) 30 of the conduit clamp systems 1′ are tightened. The number of wall element(s) 24 or the distance between wall element(s) 24 can be adjusted or reconfigured at any time easily by the user. Thus, a plurality of conduit clamp systems 1′ are used in construction of a shelf that includes at least one wall element 24 and a plurality of pipes 20 without drilling any holes in the wall element 24 or the pipe 20 (first object 20) as well as without using any tools.

The wall element 24 can include any element capable of handling loads of articles placed on the wall element 24 and the wall element 24 could include but not limited to: a wooden plank, aluminium panels, trays, vacuum panels, plastic panels and so on

In an embodiment (not shown in figures), the present invention is related to a conduit clamp system 1″, according to a third embodiment of the present invention. The conduit clamp system 1″ is similar to conduit clamp system 1 of FIGS. 1-7 except that the conduit clamp system 1″ comprises a plurality of (more than one) loop clamps 40. The loop clamps 40 are individually referred as loop clamp 40a, loop clamp 40b, loop clamp 40c and so on. The conduit clamp system 1″ comprises a U-shaped member 10, a fastener 30, and a plurality of (more than one) loop clamps 40. The U-shaped member 10 is configured to encircle (nestle) around at least a portion of a first object 20. The U-shaped member 10 comprises a screw hole 12 that is configured to receive a fastener 30. Each of the loop clamps 40 is configured to substantially encircle (nestle) around a different (unique) second object 22 such that the loop clamp 40a is configured to substantially encircle (nestle) around a second object 22a, loop clamp 40b is configured to substantially encircle (nestle) around a second object 22b, loop clamp 40c is configured to substantially encircle (nestle) around a second object 22c and so on. Each of the loop clamps 40 comprises a first screw hole 42 and a second screw hole 44. Each of the first hole 42 and the second hole 44 are configured to receive a fastener 30. The fastener 30 comprises a fastener head 32, a screw portion 34 comprising screw like threads, and a screw tip 36. The fastener head 32 is configured to be manipulated (rotated) by a user using their hands, without requiring any tools. The fastener 30 is configured to rotationally couple the plurality of loop clamps 40 with the U-shaped member 10 such that the plurality of loop clamps 40 can rotate relative to the U-shaped member 10 around a rotation axis and vice-versa. The rotation axis of the plurality of loop clamps 40 and the longitudinal axis of the fastener 30 are substantially same. The fastener 30 extends (passes) through the first screw hole 42 of the plurality of loop clamps 40, the second screw hole 44 of the plurality of loop clamps 40 as well as the screw hole 12 of the U-shaped member 10.

In various embodiments, the U-shaped member 10 is configured to be installed on a ¾-inch EMT conduit {the most common size}. The U-shaped member 10 is of a shape that can be built to fit virtually any size and shape of at least a portion of the first object 20. For instance, the original design has a one-inch inside diameter to fit ¾-inch EMT conduit which has a 0.922-inch outside diameter. A smaller or larger first object 20 would require different sized interior holes to match up with different sized outside diameters of first object 20. The shape of the U-shaped member 10 allows the U-shaped member 10 to be clamped or unclamped from the first object 20. The thickness of the U-shaped member 10 provides reinforcement and prevents the U-shaped member 10 from spreading as the fastener 30 is rotated (tightened). The U-shaped member 10 also acts as a solid base to support loop clamps 40 and second object 22.

An exemplary method of making the conduit clamp system 1 of the present invention will now be described. For use with the most common conduit (¾-inch EMT/0.922 inch outside diameter) construction of the U-shaped member 10 begins with thick-walled aluminum pipe. Outside diameter may be two inches and the inside diameter is one inch. The aluminum pipe is cut to ⅞th inch thickness. The sharp edges of the aluminum pipe are chamfered or de-burred by any conventional process already known in art. Then the section of aluminum pipe is notched to remove exactly 0.095 inch of material from the outside of the disc to the center hole. This notch may not be centered but installed to leave a 0.05 inch “cradle” in one wall of the notch. The pointed ends of the notch are now “snubbed” to remove enough material to allow for flush mounting on wall mounted conduit (total finished length to be 1.422 inches as per illustration). This section is again sanded/de-burred. Now a 13/64-inch hole is drilled perfectly perpendicular to the notch but a degree or so above center to ensure security of mounting. This hole is tapped with a ¼-inch course tap. Then a fastener 30 (1½-inch-long thumbscrew) is affixed with a one-inch section of ¼ inch clear medical tube. This can then hold ⅞-inch loop clamps 40 with ¼-inch mounting holes.

The material of the conduit clamp system 1 could include but are not limited to: aluminium, plastics, iron, steel, copper, metal alloys, and so on. Aluminum remains the best option combining immense strength, ease of construction, weight of shipping, and weight-sensitive aeronautic applications. Aluminum also dissipates heat and wouldn't melt like plastic in high temperature applications i.e., engine compartments, desert conditions or adjacent to heaters. A plastic version could be made for some low-duty applications that do not involve high loads.

The U-shaped member 10 can be used on virtually any size and shape of the first object 20. Loop clamps 40 are inexpensive, already known in the art and can also be purchased in multiple sizes and with multiple sized mounting holes.

Further, it should be understood that the conduit clamp system (1, 1′, 1″) of the present invention could be used in any field (application) including but not limited to: construction, automotive, aeronautic, or nautical, domestic use, furniture, factory use, pipes, tubes, ducts, bathroom fittings, woodworking, cabinet, medical field, after-market wiring harness, fuel lines, linkages and so on. Virtually any size of the conduit clamp system (1, 1′, 1″) can be fabricated to allow innumerable applications.

As used in this application, the term “about” or “approximately” refers to a range of values within plus or minus 10% of the specified number. And the term “substantially” refers to up to 90% or more of an entirety.

It should be well understood that the conduit clamp system (1, 1′, 1″) and their associated parts and components are very similar and could be interchangeably used. Thus, in an example, various embodiments associated with the conduit clamp system (1, 1″) could also be used (applicable) in conjunction with the conduit clamp system (1′) and vice-versa.

Finally, while the present invention has been described above with reference to various exemplary embodiments, many changes, combinations, and modifications may be made to the exemplary embodiments without departing from the scope of the present invention. For example, the various components may be implemented in alternative ways. These alternatives can be suitably selected depending upon the particular application or in consideration of any number of factors associated with the operation of the device. In addition, the techniques described herein may be extended or modified for use with other types of devices. These and other changes or modifications are intended to be included within the scope of the present invention.

What is claimed is:

1. A conduit clamp system (1, 1″), comprising:
a U-shaped member (10) configured to encircle around at least a portion of a first object (20), wherein the U-shaped member (10) comprises a screw hole (12);
at least one loop clamp (40) configured to substantially encircle around a second object (22), wherein the loop clamp(s) (40) comprises a first screw hole (42) and a second screw hole (44);
a fastener (30) configured to extend through the first screw hole (42) of the loop clamp(s) (40), the second screw hole (44) of the loop clamp(s) (40) as well as the screw hole (12) of the U-shaped member (10), wherein the fastener (30) comprises a fastener head (32), a screw portion (34) comprising screw-like threads, and a screw tip (36);
Wherein the fastener (30) is configured to rotationally couple the loop clamp(s) (40) with the U-shaped member (10) such that the loop clamp(s) (40) can rotate in two directions relative to the U-shaped member (10) along a longitudinal axis of the fastener (30); and
Wherein the fastener (30) is configured to be rotated in a first direction relative to the U-shaped member (10) to enable the screw tip (36) of the fastener (30) to contact against the periphery of the first object (20), wherein the fastener head (32) is configured to be manipulated by the hands of a user in a tool-less manner.

2. The conduit clamp system (1, 1″) according to claim 1, wherein the fastener (30) is a thumbscrew.

3. The conduit clamp system (1, 1″) according to claim 1, wherein an elastic tube (50) is configured to surround the screw portion (34) of the fastener (30).

4. The conduit clamp system (1, 1″) according to claim 1, wherein the loop clamp (40) is configured to rotate relative to the U-shaped member (10) in 360 degrees of rotation.

5. The conduit clamp system (1, 1″) according to claim 1, wherein the first object (20) and/or the second object (22) is selected from a group comprising of: construction pipes, conduits, hoses, wiring harnesses, electrical conduits, bumper, mechanical linkages, frame rails, tubes, curtain rods, frame parts, rods, planks, plywood, auto frame, airplane/ship bulkhead, storage cabinet, and fireplace mantle.

6. The conduit clamp system (1, 1″) according to claim 1, wherein an inner portion (15) of the U-shaped member (10) and/or an inner portion (45) of the loop clamp (40) comprises a friction lining respectively.

7. The conduit clamp system (1, 1″) according to claim 1, wherein the conduit clamp system (1, 1″) does not require any installation holes drilled in place.

8. A method for constructing a shelf including a plurality of pipes (20) and at least one wall element (24), the method comprising the steps of:
arranging at least one conduit clamp system (1′) on at least one of the pipe (20) selected from the plurality of pipes (20) arranged in a frame; wherein each of the conduit clamp system(s) (1′) comprises:
a U-shaped member (10) configured to encircle around at least a portion of a pipe (20), wherein the U-shaped member (10) comprises a screw hole (12) and a top surface (14),
A fastener (30) configured to extend through the screw hole (12) of the U-shaped member (10), wherein the fastener (30) comprises a fastener head (32), a screw portion (34) comprising screw-like threads, and a screw tip (36);
rotating the fastener (30) relative to the U-shaped member (10) in a first direction to enable the screw tip (36) of the fastener (30) to contact against the periphery of the pipe (20), wherein the fastener head (32) is configured to be manipulated by the hands of a user in a tool-less manner; and
arranging at least one wall element (24) on top of the top surface(s) (14) of the U-shaped member (10) wherein the top surface(s) (14) of the U-shaped member (10) is configured to act as a resting surface(s) for the wall element(s) (24).

9. The method for constructing a shelf according to claim 8, comprises an additional step of forming a frame of the shelf by connecting a plurality of pipes (20).

10. The method for constructing a shelf according to claim 9, wherein the plurality of pipes (20) are connected by welding, snap-fitting, or threaded couplings.

11. The method for constructing a shelf according to claim 8, wherein the wall element(s) (24) is selected from a group comprising of: wooden plank, aluminum panels, trays, vacuum panels, and plastic panels.

12. The method for constructing a shelf according to claim 8, wherein the wall element(s) (24) is configured for storing and/or displaying article(s) that are placed on the wall element(s) (24).

13. The method for constructing a shelf according to claim 8, wherein the fastener (30) is a thumbscrew.

14. The method for constructing a shelf according to claim 8, wherein an inner portion (15) of the U-shaped member (10) comprises a friction lining.

15. The method for constructing a shelf according to claim 8, wherein the conduit clamp system (1′) does not require any installation holes drilled in place.
